(19) United States
(12) Patent Application Publication
(10) Pub. No.: US 2020/0305442 A1
(43) Pub. Date: Oct. 1, 2020

(54) ROTARY DOUGH SHAPER WITH ADJUSTABLE BACK PLATE ASSEMBLY

(71) Applicant: Radco Infusion Technologies, LLC, Toledo, OH (US)

(72) Inventor: Washington I. McGilvery, Liberty Center, OH (US)

(21) Appl. No.: 16/367,466

(22) Filed: Mar. 28, 2019

(51) Int. Cl. A21C 3/02; A23P 30/10

(52) U.S. Cl. CPC A21C 3/02; A23P 30/10

(57) ABSTRACT

A rotary dough shaper including a drive assembly, a support assembly, and a rolling assembly. The rolling assembly comprises a gauging drum having an external surface and an adjustable back plate having an internal surface. The support assembly supports the gauging drum and the adjustable back plate such that a rolling gap is formed therebetween, and the gauging drum is rotatably coupled to the support assembly such that the gauging drum rotates with respect to the support assembly to roll a dough ball between the adjustable back plate and the gauging drum.

### TECHNICAL FIELD

The present specification generally relates to molding dough and, more specifically, to systems and methods of molding dough using a rotary dough shaper with an adjustable back plate.

### BACKGROUND

Many variables affect the production quality of a dough rolling and molding system. For example: dough composition and ingredient quality, dough temperature and age, ambient temperature and humidity, process and processing times, and various other factors. Engineering dough rolling and molding assemblies that can consistently produce dough with uniform composition and dimensions requires precise control of these variables. Additionally, sheeting dough prior to rolling and molding may make producing dough balls with uniform characteristics more difficult due to the introduction of sheer stress. Accordingly, a rotary dough shaper with an adjustable back plate may be used to produce dough balls with uniform composition and dimensions without sheeting the dough prior to introduction to rotary dough shaper.

### SUMMARY

In one embodiment, a rotary dough shaper includes a drive assembly, a support assembly, and a rolling assembly. The rolling assembly comprises a gauging drum having an external surface and an adjustable back plate having an internal surface. The support assembly supports the gauging drum and the adjustable back plate such that a rolling gap is formed therebetween, and the gauging drum is rotatably coupled to the support assembly such that the gauging drum rotates with respect to the support assembly to roll a dough ball between the adjustable back plate and the gauging drum.

In another embodiment, a support assembly for an adjustable back plate of a rotary dough shaper includes an adjusting box assembly, and a back plate mount. The adjusting box assembly and the back plate mount are configured to adjust the size of a rolling gap between the adjustable back plate and a gauging roller to change the shape of a dough ball rolling between the adjustable back plate and the gauging roller in the rolling gap.

In yet another embodiment, a method of rolling a dough ball in preparations for baking the dough includes placing a dough ball at the top of a rotating gauging drum such that it enters a sheeting gap between the gauging drum and the adjustable back plate at a lip, causing the dough ball to roll between the gauging drum and the adjustable back plate, and retrieving the dough ball from a nip between the adjustable back plate and the gauging drum. The distance between the gauging drum and the adjustable back plate is constant along a production direction between the lip and the nip.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a rotary dough shaper assembly with an adjustable back plate for rolling one or more molds of dough, according to one or more embodiments shown and described herein;

FIG. 2 depicts the rotary dough shaper assembly of FIG. 1 in an exploded schematic view, according to one or more embodiments shown and described herein;

FIG. 3 depicts a side view of the rotary dough shaper assembly, according to one or more embodiments shown and described herein;

FIG. 4 depicts a schematic view of a top of an adjustable back plate, according to one or more embodiments shown and described herein;

FIG. 5A depicts a lower box housing of an adjusting box assembly, according to one or more embodiments shown and described herein; and

FIG. 5B depicts the adjusting box assembly of FIG. 5A in an exploded view, according to one or more embodiments shown and described herein.

### DETAILED DESCRIPTION

Producing dough in convenient size and shape for industrial baking may require sheeting the dough. Dough sheeting may require compressing a mold of dough (e.g., a ball of dough) between two or more rotating rollers. In prior art processes, once the dough ball is sheeted into a dough sheet, it may then pass through one or several gauging rollers that may reduce the dough to a required thickness. After this, the dough sheet may be shaped into a desired dough product. Such sheeting technology may be used in industrial production machines for industrial bakeries. Dough sheeting technology may be used for the production of laminated dough products like croissants and pastries, but it is also suitable for the production of bread, flatbread, and pizza.

A dough sheeter generally compacts dough into a sheet of even thickness and a dough sheeter may remove any unwanted holes in the dough and may smooth the edges of a dough ball. In some instances, a sheeter may reintroduce cutter scrap to a dough ball of fresh dough, recycling unused dough. In many dough forming processes, the dough is introduced to a gauging roller after it has been sheeted. Sheeting dough may introduce some stress to the gluten in the dough, however. When the sheeter compacts the dough to remove air inevitably some stresses (e.g., shear stress) will affect the gluten structure. Removing the sheeting roller from this process, that is, by simply introducing the dough to the gauging roller without sheeting the dough first. By removing the sheeting roller from the dough balling process, it may be possible to avoid or inhibit the introduction of such stress into dough balls.

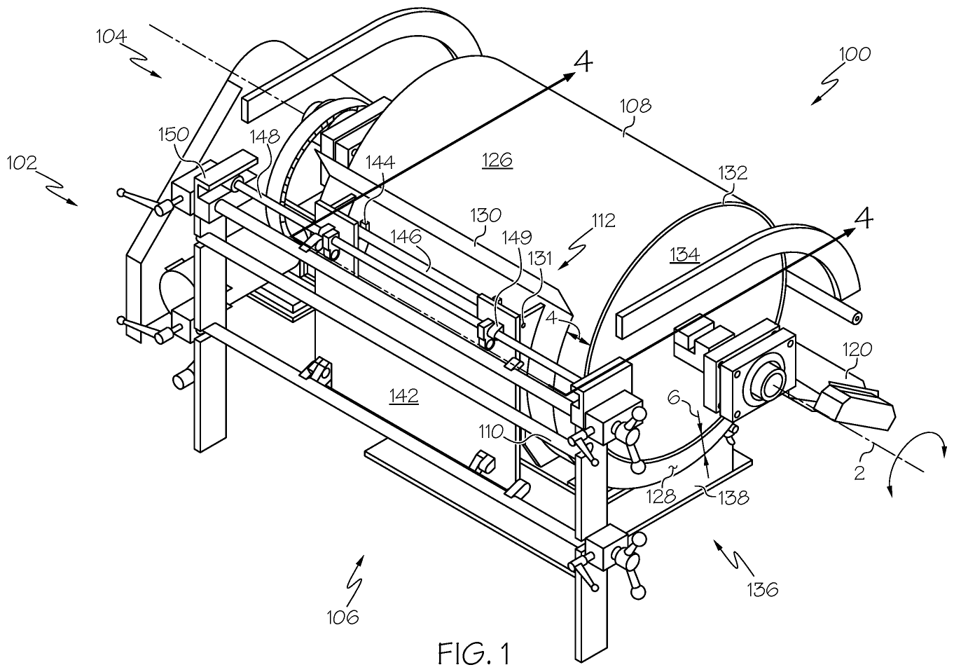

Embodiments of the present disclosure are directed to a rotary dough shaper with an adjustable back plate assembly that does not require a dough ball to be sheeted before it is introduced to a gauging roller. Generally referring to FIG. 1, a user (e.g., a baker) may place a dough ball (e.g., a ball of dough) on top of a gauging drum that rotates at an adjustable speed. As the gauging drum rotates, the dough ball may be caught between the gauging drum and a mouth of a first back plate section of the adjustable back plate assembly. The mouth of the first back plate section may guide the dough ball between the gauging drum and the first back plate section.

In some embodiments, the distance between the adjustable back plate assembly and the gauging drum may be constant along the circumference of the gauging drum. The dough ball may be rolled in a rolling gap between the gauging drum and the adjustable back plate assembly. Because the gauging drum is the only moving part, friction between the gauging drum and the adjustable back plate assembly causes the dough ball to roll between the gauging drum and the adjustable back plate assembly, advancing the dough ball through the rotary dough shaper.

As the dough ball rolls through the machine between the adjustable back plate assembly and the gauging drum, a dough shape with no seam is formed by flattening the dough ball, which may prevent the unwanted introduction of air into an interior of the dough ball and produce an otherwise superior dough ball. Once the dough ball passes through the circumferential length of the rolling gap, the sealed dough ball may be discharged into a catch pan.

In embodiments described herein, it is important that dough not stick to the components of the assembly. The dough is necessarily in contact with components of the assembly throughout nearly all of the dough balling process, but any sticking of the dough to assembly components could result in wasted dough, backups in the system leading to malfunction, etc. Accordingly, the components of the assembly that contact dough may have external surfaces to which dough does not tend to stick. Moreover, jurisdictional and regulatory entities may require certain dough contact surfaces to meet sanitation requirements. For example, it may be necessary that dough contact surfaces resist the growth of mold, bacteria, and/or other biologics.

Reference will now be made in detail to embodiments of the rotary dough shaper, examples of which are illustrated in the accompanying drawings. Whenever possible, the same reference numerals will be used throughout the drawings to refer to the same or like parts. Referring now to FIG. 1, a rotary dough shaper 100 is shown. The rotary dough shaper 100 includes a rolling assembly 102 including a gauging drum 108 and an adjustable back plate 110, a drive assembly 104, and a support assembly 106. The drive assembly 104 turns one or more components (e.g., the gauging drum 108) to cause dough balls to travel between the gauging drum 108 and the adjustable back plate 110. The support assembly 106 supports the rolling assembly 102 and the drive assembly 104. Dough balls may be placed on top of the gauging drum 108 and as the gauging drum 108 turns, the dough may be pressed and rolled in a rolling gap 112 between the gauging drum 108 and one or more components of the rolling assembly 102. As the dough rolls between the gauging drum 108 and components of the rolling assembly 102, a seam formed in the dough may be sealed producing a seamless dough ball.

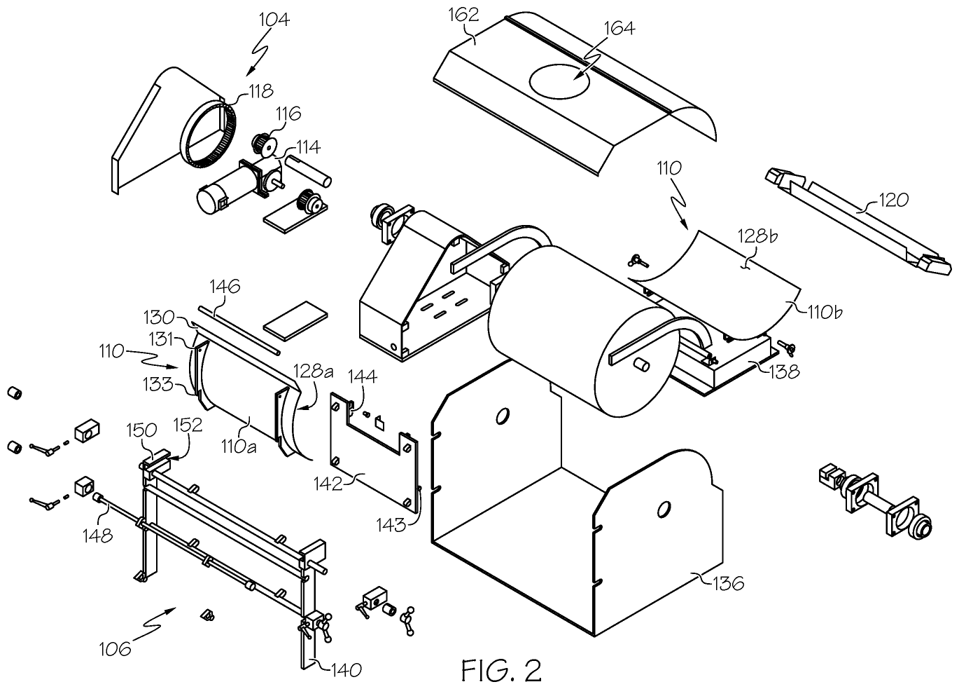

The rolling assembly 102 includes the gauging drum 108, the adjustable back plate 110 including a lip 130, and a catch pan 120. In some embodiments, the adjustable back plate 110 may be separated into multiple sections and each section may be individually adjustable to change a dimension of the rolling gap 112 as described in greater detail herein. For example, as shown in FIG. 2, the adjustable back plate 110 may be separated into an adjustable back plate upper portion 110a and an adjustable back plate lower portion 110b. Referring to FIGS. 1 and 2, the adjustable back plate 110 may be separated from the gauging drum 108 by the rolling gap 112. The size of the rolling gap 112 may be adjustable by moving one or more portions of the adjustable back plate 110 as described in greater detail herein. The gauging drum 108 may be supported by the support assembly 106 and may rotate about an axis 2. In some embodiments, the gauging drum 108 is coupled to the support assembly 106 at a rolling bearing that rolls around the axis 2. In a production mode, the gauging drum 108 may rotate in a production direction (i.e., counter-clockwise in the particular illustrated example shown in FIG. 1). As the gauging drum 108 rotates, dough may roll between the gauging drum 108 and the adjustable back plate 110 to form rolled dough as explained in greater detail herein. The catch pan 120 may catch dough that has passed through the rolling gap 112 between the gauging drum 108 and the adjustable back plate 110.

The gauging drum 108 is a rotating cylinder and may have an external surface 126 that is substantially uniform along the perimeter of the rotating cylinder. In some embodiments, the external surface 126 may have a surface texture or surface roughness that may impart one or more characteristics to the dough ball or may increase the friction between the dough ball and the gauging drum 108 without causing the dough ball or portions thereof to stick to the gauging drum 108. Optionally, the surface texture is sufficient to meet the standards of NSF/ANSI 8: Commercial Powered Food Preparation Equipment. That is, the gauging drum 108 may cause the dough ball to roll between gauging drum 108 and the adjustable back plate 110 as a substantially intact dough ball without imparting internal shear stress in the dough that could cause dough to stick to the gauging drum 108. In some embodiments, the gauging drum 108 may include an external layer 132 that surrounds a core 134. In some embodiments, the external layer 132 may cover all or substantially all of the core 134. In other embodiments, the external layer 132 may cover only a portion of the core 134. In some embodiments, the external layer 132 may be a single, continuous cylindrical sheet or layer of material, such as, for example, nickel, chromium, copper, or alloys thereof, or steel. In some embodiments, the external layer 132 may be formed from one or more portions of material, such as, for example, one or more portions of nickel, chromium, copper, or alloys thereof, or steel. In some embodiments, one or more portions of the external layer or substantially all of the external layer 132 is made of type 304/2b stainless steel. In some embodiments, the core 134 is made of a metal or metal alloy, such as, for example, nickel, chromium, copper, or alloys thereof, or steel. In some embodiments, the core 134 is made of type 304/2b stainless steel. In embodiments in which the external layer 132 and the core 134 are the same material, the gauging drum 108 may or may not be monolithic. The gauging drum 108 is driven radially (i.e., in the +/− feed direction) about the axis 2 by the drive assembly 104.

The adjustable back plate 110 may be a plate made from one or more sections. In some embodiments, the adjustable back plate 110 forms a cylindrical plane that is substantially parallel to the external surface 126 of the gauging drum 108 in the +/− feed direction. In some embodiments, the distance 4 between the adjustable back plate 110 and the external surface 126 changes in the feed direction. That is, the distance between the adjustable back plate 110 and the external surface 126 may increase or decrease in the feed direction as described in greater detail below. One or more portions of the adjustable back plate 110 may be made of a metal or metal alloy, such as, for example, nickel, chromium, copper, or alloys thereof, or steel. In some embodiments, the adjustable back plate 110 is made of type 304/2b stainless steel. In some embodiments, an external surface of the adjustable back plate 110 is made of type 304/2b stainless steel.

An interior surface 128 of the adjustable back plate 110 may substantially compliment a cylindrical shape of the gauging drum 108 such that dough that is between the gauging drum 108 and the adjustable back plate 110 rolls through the rolling gap 112 as the gauging drum 108 rotates. In some embodiments, the adjustable back plate 110 includes a lip 130. The lip 130 may extend radially from the adjustable back plate 110 in a distance opposite the gauging drum 108 to catch dough between the adjustable back plate 110 and the gauging drum 108. In some embodiments, the lip 130 may have an adjustable angle between the adjustable back plate 110 and the gauging drum 108 at an edge interface between the adjustable back plate 110 and the lip 130. For example, the lip 130 may be formed on a hinge or other adjustable connection such that it can pivot with respect to the adjustable back plate to change the angle between the lip 130 and the external surface 126 of the gauging drum 108. Accordingly, the angle between the lip 130 and the gauging drum 108 can be adjusted based on the size of dough balls that are to be rolled between the adjustable back plate 110 and the gauging drum 108. In some embodiments, the lip 130 extends an entire lateral distance (i.e., width) of the gauging drum 108. In other embodiments, the lip 130 extends only a portion or portions of the lateral distance of the gauging drum. One or more portions of the lip 130 may be made of a metal or metal alloy, such as, for example, nickel, chromium, copper, or alloys thereof, or steel. In some embodiments, the adjustable back plate 110 is made of type 304/2b stainless steel. In some embodiments, the lip 130 is monolithic with the adjustable back plate 110. In other embodiments, the adjustable back plate 110 and the lip 130 are separate components.

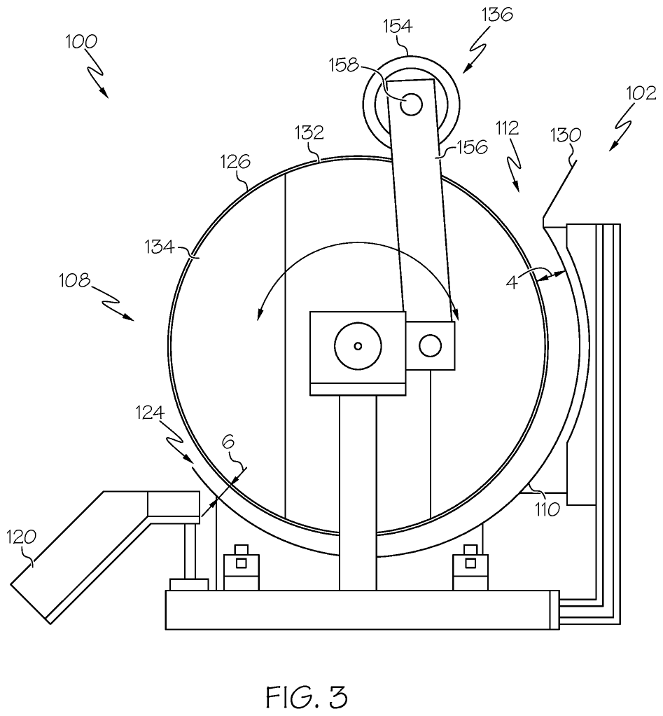

Referring to FIGS. 1 and 3, the rolling gap 112 extends along a circumferential portion of the gauging drum 108 between the gauging drum 108 and the adjustable back plate 110. At the end of the rolling gap 112 is a nip 124 where dough exits the rolling gap 112 for the catch pan 120. The dough rolls between the gauging drum 108 and the adjustable back plate 110 as the gauging drum 108 rotates and translates along a circumferential length of the adjustable back plate 110 until it exits the rolling gap 112 into the catch pan 120. In embodiments, the distance between an external surface 126 of the gauging drum 108 and an interior surface 128 of the adjustable back plate 110 may decrease along the dough-rolling direction such that as the gauging drum 108 rotates in the feed direction, the dough changes its dimension as it rotates. For example, as the dough passes along the circumferential length within the rolling gap 112, the dough may take a cylindrical shape. A radius of the cylindrical shape may decrease proportionately to the decrease in the distance between the external surface 126 of the gauging drum 108 and the interior surface 128 of the adjustable back plate 110.

Although not shown in the particular embodiment shown in FIGS. 1 and 3, some embodiments of the rotary dough shaper 100 may include a nip guard near the nip 124. Embodiments of the nip guard include nip guards that may comprise a fixed or adjustable distance between the nip and the gauging drum 108. The nip guard may generally inhibit a user's fingers or other appendages from entering the rolling gap 112 or otherwise entering a position where they may contact the rotary dough shaper 100 between the rotating gauging drum 108 and other components.

The dimension of the rolling gap 112 may be adjustable by adjusting the position of the adjustable back plate 110 with respect to the gauging drum 108. That is, in some embodiments, the distance between an interior surface 128 of the adjustable back plate 110 and an external surface 126 of the gauging drum 108 is adjustable. Additionally, in some embodiments, the distance between the interior surface 128 and the external surface 126 may vary along the feed direction or along a width of the rotary dough shaper 100 as will be described in greater detail herein. For example, as shown in FIGS. 1 and 3, the distance 4 between the external surface 126 and the interior surface 128 is greater than the distance 6 between the external surface 126 and the interior surface 128. The change in distance between the external surface 126 and the interior surface 128 may affect the dimension (e.g., radius) of the dough as described in greater detail herein. In other embodiments, the distance 4 and the distance 6 may be substantially equal.

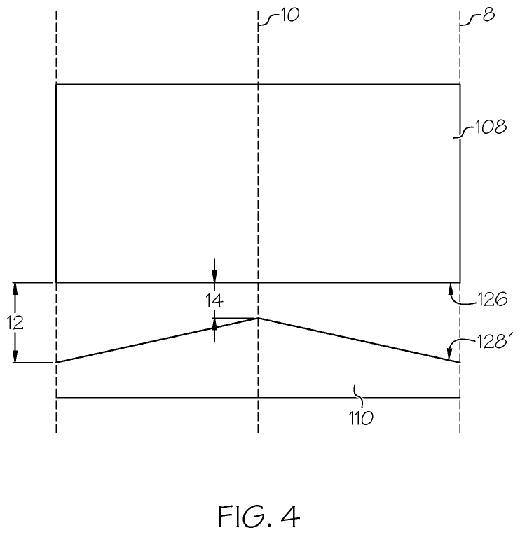

Briefly referring to FIG. 4, in some embodiments, the adjustable back plate 110 includes one or more features for affecting the shape of the moldable dough (i.e., a “dough shape affecting feature”). Affecting the shape of the moldable dough may, for example, impart desirable properties to the dough ball before it is baked. For example, the dough ball may be stretched, pinched, or otherwise shaped by the various shapes between the adjustable back plate 110 and the gauging drum 108 or other features. One example feature of the adjustable back plate 110 is a convexed interior surface 128′ that is shaped to stretch the moldable dough along a longitudinal dimension of the dough as the dough passes through the rolling gap 112 in the feed direction. The term “convexed” used in convexed interior surface 128′ may be with respect to the adjustable back plate 110. The distance 12 between the external surface 126 of the gauging drum 108 and the interior surface 128 of the adjustable back plate 110 is greater at the lateral ends 8 than the distance 14 between the external surface 126 and the interior surface 128 at the center 10. Because the convexed interior surface 128′ is convexed, the moldable dough between the interior surface 128 and the external surface 126 of the gauging drum 108 is forced toward lateral ends 8 of the adjustable back plate 110 from the center 10 as the gauging drum 108 rotates and the moldable dough passes through the rolling gap 112 in the feed direction. As shown in FIG. 4, the feed direction is into the paper. In some embodiments, the difference between the distance 12 and the distance 14 varies along the feed direction.

Other types of features for affecting the shape of the moldable dough are considered. For example, a concave interior surface may cause a dough ball to coalesce toward an interior of the dough as it proceeds along the feed direction, resulting in dough balls that are thicker near a middle of the dough ball. In some embodiments, the adjustable back plate 110 may be formed with grooves, shapes, indentations, dimples, or other features to impart some desirable characteristic to the dough. In some embodiments, the external surface 126 of the gauging drum 108 may include corresponding or separate features. For example, in some embodiments, the external surface 126 of the gauging drum may include a convexed or concave outer profile or an outer profile with one or more features such as the grooves, shapes, indentations, dimples, or other features listed above. Accordingly, dough balls may be produced having various characteristics imparted by the external surface 126 of the gauging drum 108 and the interior surface 128 of the adjustable back plate 110.

Referring to FIGS. 1 and 2, the drive assembly 104 may include a motor 114 which may be controlled by one or more corresponding motor controllers (not shown), a timing belt 118, and one or more additional components for translating the rotational motion of the motor 114 into rotational motion of the gauging drum 108, such as the timing belt pulley 116. The drive assembly 104 may rotate the gauging drum 108 about the axis 2 to force dough through the rolling gap 112 to roll the dough. In some embodiments, the drive assembly 104 operates the gauging drum 108 at an adjustable, selectable speed. In some embodiments, the motor 114 may be replaced by any other suitable drive means, for example, a mechanical, electrical, pneumatic, or hydraulic actuator, a spring, an engine, or some other suitable mechanism.

Still referring to FIGS. 1 and 2, the support assembly 106 may include a base frame 136. The base frame 136 may support one or more components of the drive assembly 104 and the rolling assembly 102. The base frame 136 may be made of a rigid material, such as, for example, a metal or a metal alloy such as tin, aluminum, copper, steel, or combinations thereof. In some embodiments, the base frame 136 is made of type 304/2b stainless steel. The base frame 136 may be rigidly coupled to one or more other components of the rotary dough shaper 100. For example, an adjusting box assembly 138 may be coupled to the base frame 136. Other components of the rotary dough shaper 100 may be movably coupled to the base frame 136. For example, the gauging drum 108 may be rotatively coupled to the base frame 136.

The support assembly 106 may further include a frame structure 140. The frame structure 140 may support a back plate mount 142 that may support one or more portions of the adjustable back plate 110. The back plate mount 142 may include mounting hooks 144 that support and hold a rod 146 that may fix to the adjustable back plate 110 at connection locations 131 and lower hinges 133. The mounting hooks 144 may hold the rod 146 to support the adjustable back plate 110 and the lower hinges 133 may slide between the back plate mount 142 and an adjustable back plate pin 143 (as shown behind the adjustable back plate in FIGS. 1 and 2). The back plate mount 142 may be movably fixed to the frame structure 140 such that it pivots about the adjustable back plate pin 143 and is moved forward and aft with a stabilizing shaft 148. The back plate mount 142 may connect to the stabilizing shaft 148 at one or more fasteners 149 on the back of the back plate mount 142. The stabilizing shaft 148 may pass through the fasteners 149 and be supported in a vertical position by slots 152 in guide blocks 150. The stabilizing shaft 148 can move back and forth in a lateral direction through the slots 152 permitting lateral movement of the adjustable back plate 110.

Referring to FIGS. 1, 2, 5A, and 5B, the adjusting box assembly 138 may adjust the distance 4, 6 between the adjustable back plate 110 and the gauging drum 108. For example, the adjusting box assembly 138 may move one or more portions of the adjustable back plate 110 toward or away from the gauging drum 108.

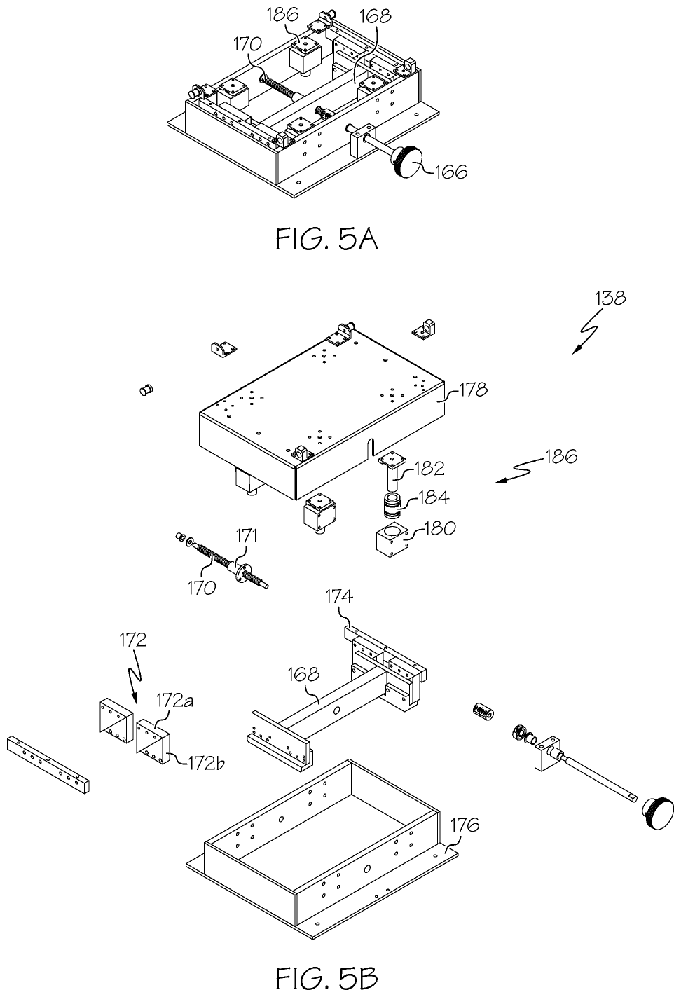

FIGS. 5A and 5B show the adjusting box assembly 138 in a partially assembled view and an exploded view, respectively. The adjusting box assembly 138 includes a lower box housing 176 and an upper box housing 178. The upper box housing 178 may be coupled to the adjustable back plate lower portion 110b as described herein and the adjusting box assembly 138 may adjust a height of the upper box housing 178 with respect to the lower box housing 176 to adjust a distance between the adjustable back plate lower portion 110b and the gauging drum 108.

The lower box housing 176 includes, among other things, an adjusting knob 166 that is coupled to an adjusting bolt 170. The adjusting bolt 170 is moveably coupled to an adjusting wall 168. The adjusting bolt 170 may be, for example, a threaded fastener that is threaded through an adjusting nut 171 that is fixed to the adjusting wall 168. A user may turn the adjusting knob 166 to pass the adjusting bolt 170 through the adjusting nut 171, moving the adjusting wall 168 with respect to the adjusting knob 166.

The adjusting wall 168 may be fixed to one or more sloped wedges 172, which may include a sloped wedge upper portion 172a and a sloped wedge lower portion 172b. In the particular embodiment depicted in FIGS. 5A and 5B, the adjusting wall 168 is coupled to the sloped wedge lower portion 172b. The sloped wedge upper portion 172a and sloped wedge lower portion 172b meet at a sloped interface. As the adjusting wall 168 moves in a first direction, it moves the sloped wedge lower portion 172b with respect to the sloped wedge upper portion 172a and the sloped wedge upper portion 172a is forced upward by the contact with the sloped wedge lower portion 172b. The sloped wedge lower portion 172b may move downward as the adjusting wall 168 moves in a second direction due to the force of gravity and/or to one or more springs, dampers, etc.

The sloped wedge upper portion 172a is coupled to the upper box housing 178 through a bar 174. Thus, as the sloped wedge upper portion 172a moves with respect to the sloped wedge lower portion 172b, the upper box housing 178 is forced upward or downward to adjust a height of the adjustable back plate lower portion 110b and a distance between the adjustable back plate lower portion 110b and the gauging drum 108. The distance that the upper box housing 178 moves with respect to the lower box housing 176 is relative to the angle of the interface between the sloped wedge lower portion 172b and the sloped wedge upper portion 172a. The steeper the angle of the interface (with respect to the vertical plane) the less the adjusting wall 168 needs to move in the horizontal direction in order to move the adjustable back plate 110 (and thus the less a user needs to turn the adjusting knob 166 to affect the height of the adjustable back plate lower portion 110b). In some embodiments, adjusting the adjusting knob 166 may adjust the position of the entire adjustable back plate 110 with respect to the gauging drum 108. In some embodiments, adjusting the adjusting knob 166 may adjust only the position of the adjustable back plate lower portion 110b with respect to the gauging drum 108, such as in embodiments in which the adjustable back plate 110 is a two-piece adjustable back plate.

Referring to FIG. 2, some embodiments of the rotary dough shaper 100 may include a top plate 162 with an aperture 164 for inserting dough balls into the rotary dough shaper 100. The aperture 164 may inhibit dough balls from entering the rolling gap 112 at an unwanted position along the width of the rolling gap 112. For example, the aperture 164 may prevent dough balls from entering the rolling gap 112 away from a mid-line of the rotary dough shaper 100 with respect to a lateral dimension of the rotary dough shaper 100. A user of the rotary dough shaper 100 may drop a dough ball through the aperture onto the gauging drum 108 to roll the dough ball in the rolling gap 112. Some embodiments of the rotary dough shaper 100 may include multiple apertures 164 for introducing multiple dough balls simultaneously. Additionally, while the particular example of the aperture 164 shown in FIG. 2 is at the middle of the top plate 162, this is not required. It is contemplated that the aperture 164 could be at any position along the width of the top plate 162.

Referring to FIG. 3, some embodiments of the rotary dough shaper 100 may include a sheeting roller 154. The sheeting roller 154 may be rotatively coupled between sheeting roller arms 156 that extend upward at opposing sides of the width of the gauging drum 108. The sheeting roller arms 156 may be pivotally coupled to the rotary dough shaper 100 at pins such that the sheeting roller 154 can translate toward and away from the gauging drum 108 by pivoting the sheeting roller arms 156 about the pins to change the size of a sheeting gap between the sheeting roller 154 and the gauging drum 108. Dough may pass through the sheeting gap to prepare the dough for entering the rolling gap 112. In some embodiments, the sheeting roller 154 may be a single, continuous cylindrical sheet or layer of material, such as, for example, nickel, chromium, copper, or alloys thereof, or steel. In some embodiments, the sheeting roller 154 or portions thereof are made of type 304/2b stainless steel. In some embodiments, the distance between the sheeting roller 154 and the gauging drum 108 may be adjustable. For example, the angle of the sheeting roller arms 156 may be adjustable with respect to the gauging drum 108 (i.e., the sheeting roller arms 156 may be pivoted with respect to the rotary dough shaper 100). The distance between the sheeting roller 154 and the gauging drum 108 may change in order to allow bigger or smaller dough balls to enter the rolling gap 112. In some embodiments, the sheeting roller 154 may be individually motorized such that the sheeting roller 154 can spin on its own. In other embodiments, the sheeting roller 154 is passive (i.e., does not rotate) unless there is an object between the gauging drum 108 and the sheeting roller 154 (e.g., a dough ball).

Referring to FIGS. 1, 2, 5A, and 5B, in some embodiments, the adjustable back plate 110 may be adjusted using the adjusting box assembly 138. For example, the adjusting box assembly 138 may adjust the distance between the external surface 126 of the gauging drum 108 and the interior surface 128b of the adjustable back plate lower portion 110b with the adjusting box assembly 138. Referring specifically to FIG. 5, the adjusting box assembly 138 includes an adjusting knob 166.

Referring generally to FIGS. 1-3, a method of producing a consistently shaped dough ball using the rotary dough shaper 100 is described. The gauging drum 108 may be rotating in a production direction, turned by the drive assembly 104. The drive assembly 104 may include an electric motor that receives electrical power from a standard wall outlet, for example. In some embodiments, the drive assembly 104 may receive electrical power from a different source, such as a battery or a generator. As the drive assembly 104 turns the gauging drum 108, the user may place a ball of dough at the top portion of the gauging drum 108. In embodiments having a top plate 162 with an aperture 164, the user may place the dough ball in the aperture 164.

The dough may contact the gauging drum 108 and roll along the external layer 132 of the gauging drum 108 until the lip 130 of the adjustable back plate 110 catches the dough. The dough may then be forced by the rotational motion of the gauging drum 108 and the friction between the gauging drum 108 and the dough to roll in between the gauging drum 108 and the adjustable back plate 110. As the dough rolls between the adjustable back plate 110 and the gauging drum 108, the dough may form a cylindrical shape and a seam in the dough ball may be sealed as the dough rolls. Sealing this seam may prevent the introduction of gases into the body of the dough ball. Gases in the dough could lead to air pockets and other deformities in the shape of the baked bread as the dough is baked. Thus, sealing the seam of the dough may prevent the formation of air pockets and other deformities during baking. The dough may continue to roll through the rolling gap 112 until it exits the rolling gap 112 at the nip 124. The dough may be caught by the catch pan 120 after it leaves the nip 124.

In embodiments, one or more of the adjustable back plate portions 110a, 110b may be adjusted while the dough ball is proceeding through the dough shaper 100 between the gauging drum 108 and the adjustable back plate 110. The size of the rolling gap may be adjusted, for example, in order to impart one or more effects into the dough ball (e.g., to affect the shape of the dough ball, to affect the amount of gas trapped in the dough, etc.). In embodiments, the gauging drum 108 may roll back-and-forth with one or more dough balls between the gauging drum 108 and the adjustable back plate 110 to impart one or more desirable effects to the dough ball. For example, a dough ball may be run back-and-forth between the gauging drum 108 and the adjustable back plate 110 in order to increase a length of the dough ball. In embodiments, the dough ball may be run back-and-forth along an upper interior surface 128a between the adjustable back plate upper portion 110a in order to shape the dough ball and/or may be run along a lower interior surface 128b between the adjustable back plate lower portion 110b in order to shape the dough ball. In embodiments, the dough ball may be run along the upper interior surface 128a in a back-and-forth manner for any period of time and/or may be run along the lower interior surface 128b for any period of time in a back-and-forth manner to shape the dough ball. In embodiments, a seam of the dough ball may be closed as the dough is shaped between the upper interior surface 128a and the lower interior surface 128b.

Embodiments described herein may produce dough balls in consistent, compact form without the need for sheeting the dough. It should now be understood that a gauging roller may be used to seal a seam of a dough ball and to form the dough into a desirable shape for baking without introducing substantial stress to the dough. One or more features of the rotary dough shaper may enable the dough ball to be shaped within a rolling gap of the rotary dough shaper which may impart desirable characteristics to the dough that may enable specialty products to be baked using the dough produced by the rotary dough shaper.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A rotary dough shaper comprising:
a drive assembly;
a support assembly; and
a rolling assembly comprising:
a gauging drum having an external surface; and
an adjustable back plate having an internal surface, wherein
the support assembly supports the gauging drum and the adjustable back plate such that a rolling gap is formed therebetween, and
the gauging drum is rotatably coupled to the support assembly such that the gauging drum rotates with respect to the support assembly to roll a dough ball between the adjustable back plate and the gauging drum.

2. The rotary dough shaper of claim 1, wherein the internal surface of the adjustable back plate and the external surface of the gauging drum are substantially parallel along a length of the rolling gap.

3. The rotary dough shaper of claim 1, wherein the internal surface of the adjustable back plate tapers towards the external surface of the gauging drum along a production direction of the rolling gap.

4. The rotary dough shaper of claim 1, wherein the adjustable back plate comprises a shape affecting feature that imparts one or more characteristics to dough as the dough travels between the adjustable back plate and the gauging drum in the rolling gap.

5. The rotary dough shaper of claim 4, wherein the shape affecting feature is a convexed or concaved interior surface.

6. The rotary dough shaper of claim 1, further comprising a lip that forms a planar surface that extends along at least a portion of a width of the adjustable back plate and extends radially away from the adjustable back plate with respect to the gauging drum.

7. The rotary dough shaper of claim 6, wherein the lip is monolithic with the adjustable back plate.

8. The rotary dough shaper of claim 6, wherein the lip is pivotally connected to the adjustable back plate along an edge interface between the lip and the adjustable back plate.

9. The rotary dough shaper of claim 1, wherein the external surface of the gauging drum comprises a single, continuous cylindrical sheet of one or more of nickel, chromium, copper, or alloys thereof, or steel.

10. The rotary dough shaper of claim 7, wherein the external surface of the gauging drum comprises type 304/2b stainless steel.

11. The rotary dough shaper of claim 1, wherein the gauging drum comprises an external layer that surrounds a core.

12. The rotary dough shaper of claim 11, wherein the external surface and the core comprise the same material.

13. The rotary dough shaper of claim 1, further comprising a sheeting roller that is substantially parallel to the gauging drum that sheets the dough ball in a sheeting gap before the dough ball reaches the rolling gap.

14. The rotary dough shaper of claim 13, wherein the sheeting gap is adjustable.

15. The rotary dough shaper of claim 14, wherein the sheeting roller is held by one or more sheeting roller arms that are pivotally connected to the rotary dough shaper to pivot with respect to the rotary dough shaper.

16. The rotary dough shaper of claim 1, wherein the adjustable back plate is held in place with respect to the gauging drum by a back plate mount.

17. A support assembly for an adjustable back plate of a rotary dough shaper comprising:
an adjusting box assembly, and
a back plate mount, wherein
the adjusting box assembly and the back plate mount are configured to adjust a size of a rolling gap between the adjustable back plate and a gauging roller to change a shape of a dough ball rolling between the adjustable back plate and the gauging roller in the rolling gap.

18. The support assembly of claim 17, wherein the adjustable back plate is held in place with respect to the back plate mount by one or more mounting hooks.

19. A method of rolling a dough ball in preparations for baking dough comprising:
placing the dough ball at the top of a rotating gauging drum such that it enters a rolling gap between a gauging drum and an adjustable back plate at a lip;
causing the dough ball to roll between the gauging drum and the adjustable back plate; and
retrieving the dough ball from a nip between the adjustable back plate and the gauging drum, wherein
a distance between the gauging drum and the adjustable back plate is constant or varies along a production direction between the lip and the nip.

20. The method of claim 19, wherein the adjustable back plate comprises comprises a shape affecting feature that imparts one or more characteristics to dough as the dough travels between the adjustable back plate and the gauging drum in the rolling gap.
